(19) United States
(12) Patent Application Publication
(10) Pub. No.: US 2025/0131841 A1
(43) Pub. Date: Apr. 24, 2025

(54) AUTOMATED LEARNING SYSTEM ACCESSIBLE VIA TELEPHONIC COMMUNICATIONS

(71) Applicant: Cristian Alexander Pineda, Orlando, FL (US)

(72) Inventor: Cristian Alexander Pineda, Orlando, FL (US)

(21) Appl. No.: 18/920,884

(22) Filed: Oct. 19, 2024

Related U.S. Application Data
(60) Provisional application No. 63/545,061, filed on Oct. 20, 2023.

(51) Int. Cl. G09B 5/04; G10L 13/033; G10L 15/00; G10L 15/183; G10L 15/22; G10L 15/30; H04L 51/02; H04M 3/42; H04M 3/493

(52) U.S. Cl. CPC G09B 5/04; G10L 13/033; G10L 15/005; G10L 15/183; G10L 15/22; G10L 15/30; H04M 3/42221; H04M 3/4936; H04L 51/02; H04M 2201/39; H04M 2201/40; H04M 2203/2061

(57) ABSTRACT

This invention relates to an automated learning system and a computer implemented method employing programs, such as, artificial intelligence, large language models, multilingual speech recognition, speech-to-text, text-to-speech, speech-to-speech and speech synthesis integrated with telephony systems, to facilitate interactive learning. The system enables a user to engage in real-time voice interactions with an emulated human instructor's voice for learning a target subject of study in a conversational setting. The system operates via telephonic voice calls over analog or digital phone lines, voice over internet protocol lines and web real-time communication systems.

### CROSS-REFERENCE TO RELATED APPLICATIONS

This application claims the benefit of the U.S. Provisional Application No. 63/545,061 filed on Oct. 20, 2023, which is hereby incorporated by reference in its entirety.

### BACKGROUND OF THE INVENTION

Learning a subject, skill or discipline has long been limited to traditional methods that cannot provide on-demand immersive, and accessible experiences that replicate communication with a human instructor, subject matter expert or tutor. Traditional methods, such as, classroom instruction or sell-study often struggle to provide consistent and practical access to on-demand tuition and conversations with subject matter experts which are essential for developing skills in a student's target subject of study. The proposed solution leverages advances in artificial intelligence, large language models, speech recognition, speech-to-text, text-to-speech, and multilingual speech synthesis technologies integrated with telephony to address these limitations and provide an accessible, personalized approach to learning a target subject of study through conversation with emulated human tutors via telephony communication systems.

### SUMMARY OF THE INVENTION

An automated learning system that comprises a set of designated phone numbers that allow users to place and receive voice telephone calls to interact in real-time with artificial intelligence large language models by using natural language and more specifically the sound of a user's voice during one to one learning sessions. In various embodiments, the automated learning system provides personalized ways for users to learn a subject of study through natural conversations with an emulated human tutor in a realistic environment. Users can participate in role-playing exercises, engage in everyday conversation or request lessons on specific subjects. Moreover, the system can provide real-time feedback, correction, hints, and explanations related to the user's target subject of study, promoting better understanding and retention. During a call the system sets the spoken language by the emulated human instructor to the user's preferred language, with flexibility that allows combining the users native and target languages to be used interchangeably when the subject of study is set to learning foreign languages. The system adapts to the user's proficiency level and each of the received utterances of speech during a call, this allows users with different proficiency levels and learning needs to engage with the system and the process of learning a target subject of study at their own convenience.

To facilitate seamless communication over voice calls, the system utilizes a combination of artificial intelligence programs such as, large language models for generating contextually relevant voice interactions between a user and a human tutor voice emulated by speech synthesis programs.

The automated learning system employs programmable communication tools for making and receiving phone calls, managing inbound and outbound connections and allowing to deliver human-like tuition over traditional analog and digital phone lines, voice over internet protocol lines and web real-time communication.

The system also comprises an online system user interface where users can register for services, place calls through web real-time communication programs, set their preferences, such as, subject of study native language, target language, target subject of study level of proficiency, inbound and outbound calling preferences, a database for storing learning data, user preferences, user interactions, conversation transcripts and learning analytics in order to measure user progress and create a unique and personalized learning experience for each user.

### BRIEF DESCRIPTION OF THE DRAWINGS

The invention has additional benefits and characteristics that will be revealed on the upcoming detailed description of the invention and the associated claims, when taken in conjunction with the accompanying drawings, in which:

FIG. 1 presents a block diagram of a computing environment for an online automated learning system that is accessible via telephony communication systems, according to one embodiment.

FIG. 2 is a block diagram of an online automated learning system that is accessible via telephony communication, according to one implementation.

FIG. 3 is a flowchart for the processing of inbound voice calls from user authorized phone numbers 106 to system designated phone number lines 105.

FIG. 4 is a flowchart for the processing of outbound voice calls from system designated phone number lines 105 to user authorized phone numbers 106

FIG. 5 is a flowchart for the processing of inbound text messages from user authorized phone numbers 106 to system designated phone number lines 105

FIG. 6 is a flowchart for the processing of outbound text messages from system designated phone number lines 105 to user authorized phone numbers 106

### DETAILED DESCRIPTION

### Automated Learning System Overview

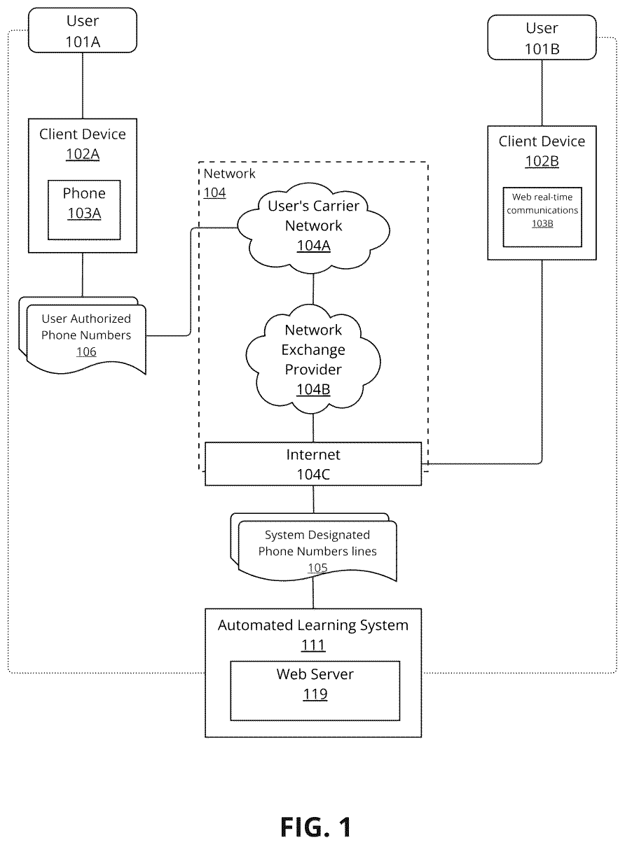

FIG. 1 presents a block diagram of a computing environment for an online automated learning system that is accessible via telephony communication systems. according to one embodiment. FIG. 1 and other figures utilize similar reference numerals to denote comparable components. Adding a letter after a reference number, such as, “101A,” indicates that the text specifically addresses the component with that specific reference numeral. A reference numeral in the text without following letters, like “104,” refers to any or all elements bearing the same number in the diagrams (e.g., “104” in the text encompasses both “104A” and “104B” in the figures).

The client device 102A: can be any hardware or software component that enables users to access and interact with the automated learning system via telephony systems. This may include landline phones, cellular phones, voice over internet protocol devices, or applications on smartphones, computers, or tablets. The client device allows users to place and receive voice calls, send text messages, and participate in real-time interactions with the automated learning system and emulated human tutors.

Phone 103A: refers to the user's phone, which can be landline phones, cellular phones, voice over internet protocol phones, smartphones or similar devices that enable the electronic transmission of speech or other data via telephonic exchange communication with the automated learning system 111. Users use their personal phone numbers registered with the system to access learning sessions.

User Authorized Phone Numbers 106: Represents the list of telephone numbers belonging to a user of the automated learning system 111. These phone numbers have been authorized by the user using the graphical user interface to make and receive calls to and from the system designated phone number lines 105. The system uses caller id to validate active participants in the automated learning system 111.

Network 104: Refers to the communication network that connects client devices 102 with the automated learning system infrastructure. This can include traditional analog landlines, digital cellular networks, or internet-based connections like voice over internet protocol and web real-time communication. In one implementation, the network comprises the users' carrier networks, network exchange providers, and the internet, potentially incorporating dedicated or private communication links like WAN, MAN, or LAN, which may not necessarily be part of the internet. The network 104 facilitates real-time audio interactions and the exchange of information between users 101 and the automated learning system 111.

User's Carrier Network 104A: The telecommunications network operated by the user's telephony service provider carrier, which may be a specific mobile, fixed- line, or voice over internet protocol operator responsible for providing voice and data services to the user's phone. It helps establish connections between the user's device 102 and the automated learning system 111 through telephony channels.

Exchange Provider 104B: The organization, system or company that provides the infrastructure for exchanging voice calls and text messages between the automated learning system and the user's carrier network. This can include, traditional telecom operators or internet-based service providers. Their role is to interconnect the communication between user's carrier networks and the automated learning system 111 cloud infrastructure.

System Designated Phone Numbers lines 105: A set of dedicated phone numbers managed by the automated learning system, which users are instructed to call for accessing one-on-one learning sessions with artificial intelligence tutors. These numbers serve as the interface for users to interact with the emulated instructor and artificial intelligence model during real-time conversations.

Automated learning system 111: It encompasses the entire technology stack necessary for providing immersive, and accessible learning experiences via voice phone calls and text messaging interactions, wherein the technology stack uses modules that process a specific function, such as, web servers, artificial intelligence, large language models, multilingual speech recognition, speech-to-text, text-to-speech, multilingual speech synthesis, databases, graphical user interfaces, and programmable telephony communication exchange and designated phone numbers.

In some embodiments, the automated learning system utilizes web real-lime communication technology for facilitating voice calls. web real-time communication allows direct audio connections between the user's browser or client device 102B and the automated learning system 111, via the user interface which depending on the implementation can be in the form of a mobile or web application.

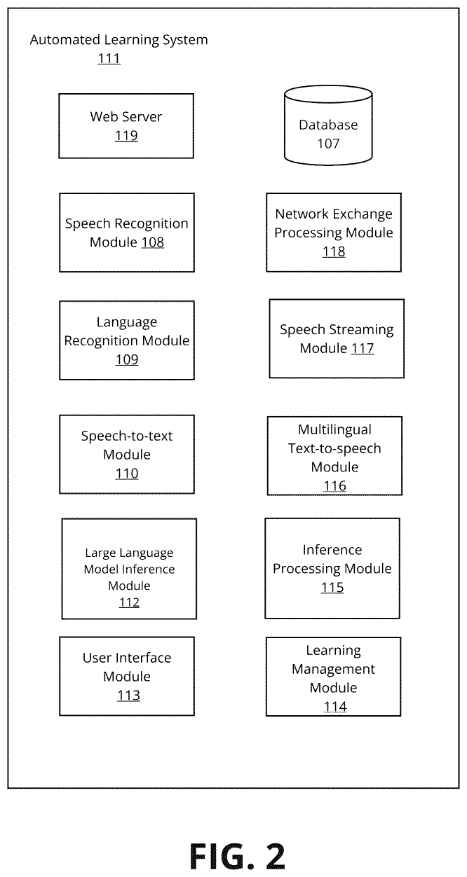

FIG. 2 is a block diagram of an online automated learning system that is accessible via telephony communication systems according to one embodiment. The online automated learning system accessible via telephony communication systems 111 includes a web server 119, a user interface module 113, a network exchange processing module 118, a speech recognition module 108, a language recognition module 109, a speech-to-text module 110, a multilingual text-to-speech module 116, a speech streaming module 117, a inference processing module 115, a artificial intelligence large language model inference module 112, a learning management module 114.

### Module Descriptions

The user interface module 113 is designed to provide users with a graphical user interface and an accessible platform for managing their learning experience. Users can register for services, set preferences, such as, native language, target subject of study, subject of study proficiency level, inbound and outbound calling preferences, and access various tools to measure progress and tailor personalized learning experiences unique to each student. It can be implemented as a mobile or web application, catering to the convenience of users accessing the system via different devices. The user interface also enables seamless communication between the automated learning system and clients through web real-time communication channels.

The network exchange processing module 118 is responsible for managing inbound and outbound phone call and text message connections between the automated learning system infrastructure and the user's carrier networks. This module ensures efficient handling of audio streams and text messages transmissions between users and the emulated human instructor via traditional analog and digital phone lines as well as voice over internet protocol and web real-time communication. It oversees connecting user's carrier networks with the system designated phone numbers, streamlining communication across various telephony channels.

The speech recognition module 108, the client device 102 receives an electrical signal representing a person's voice and converts that signal into a digital signal, the automated learning system's speech recognition module 108 receives that signal for preprocessing it to enhance the speech signal while mitigating any noise. The speech recognition module analyzes the signal using acoustic modeling to register phonemes, distinct units of speech sound that represent and distinguish one word from another.

The language recognition module 109 is responsible for identifying the language used in the input audio stream, setting the language context for subsequent processing by the speech-to-text module 110.

The speech-to-text module 110 works in parallel with the speech recognition module 108 and the language recognition module 109 to convert spoken language into text format, the speech phonemes are constructed into understandable words and sentences using language modeling facilitating real-time speech-to-text conversion.

The large language model inference module 112 employs artificial intelligence technology including but not limited to generative pre-trained transformers or bidirectional encoder representations from transformers to generate contextually rich and coherent responses during subject of study learning sessions that pair with speech synthesis modules that emulate human sounding tutors.

The inference processing module 115 formats the large language model inference module 112 responses to include speech synthesis markup language and get further process by the multilingual text-to-speech module 116.

The multilingual text-to-speech Module 116 generates human-like synthesized speech in multiple languages based on text inputs and speech synthesis markup language inserted by the inference processing module 115, enabling the system to speak in one or more languages interchangeably during learning sessions.

The speech streaming module 117 manages the raw audio stream of phone calls, ensuring real-time communication between users and the automated learning system using websockets.

The learning management module 114 tracks user progress, interaction data, conversation transcripts, and analytics to measure user proficiency improvement over time. This component analyzes performance metrics and generates personalized learning strategies based on individual needs, ensuring skill acquisition and development.

The web server 119 hosts the online user interface, allowing users to sign up for services, manage their preferences, such as, subject of study, native language, target language, proficiency level, inbound and outbound calling and text messaging preferences, and access various analytics that measure progress and help tailor learning experiences uniquely to each student. It acts as a central hub for managing interactions between all the system modules, user accounts, settings, and storing learning data.

Those of skill in the art will appreciate that the automated learning system 111 may contain additional modules relevant to its functionality, such as, social networking integrations, interactive learning tools, payments or ecommerce features, but they are not described herein since they are not directly material to the invention. Furthermore, conventional components like firewalls, authentication systems, encryption methods, network management tools, load balancers, and the like are not shown as they are not crucial to the core functionality of the invention. The automated learning system 111 can be implemented using a single computer or a network of computers, including cloud-based implementations, utilizing server-class machines equipped with high-performance graphic processing units, processors and main memory running an operating system, such as, Linux or derivatives thereof.

The operations of the automated learning system 111 described herein can be controlled through either hardware or through computer programs installed on non-transitory storage devices and executed by the processors to perform the functions outlined herein. The database 107 is implemented using non-transitory computer readable storage devices, employing suitable database management systems for data access and retrieval, such as, relational or non-relational databases (e.g., MySQL, MongoDB). The automated learning system 111 includes other essential hardware elements required for its operation, like network interfaces and protocols, input devices for data entry, and output devices for display, printing, or other presentation formats of content. As will become apparent below, the intricate operations and functions of the automated learning system 111 requires their implementation on computer systems and cannot be performed in the human mind alone.

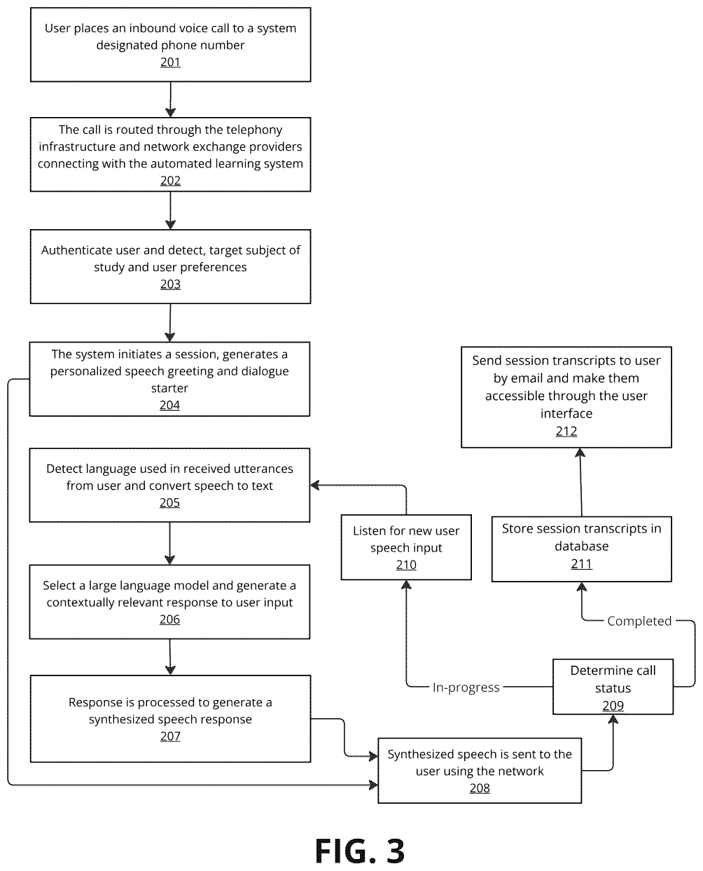

FIG. 3 is a flowchart for the process of handling inbound voice phone calls from user-authorized phone number lines 106 directed at the system designated phone numbers 105, according to one embodiment. The steps involved in processing these incoming calls facilitate real-time conversations between users and human-like tutors emulated by the automated learning system 111. In step 201 the user places an inbound voice phone call to the system designated phone numbers 105. In step 202 the call is routed through the telephony infrastructure and network exchange providers (the network 104), connecting with the automated learning system 111. In step 203 by analyzing the caller ID or using automated speech recognition, the automated learning system 111 authenticates the user and determines their preferred language, subject of study, and any other specified preferences. In step 204 upon confirming the user's identity and user preferences, the automated learning system 111 initiates a learning session and generates a personalized speech greeting along with a conversation starter to guide the learning session and real-time voice interactions with the user 101. In step 205 the automated learning system 111 uses the speech recognition and speech-to-text modules to detect the language used in the user speech input and then convert it into text format for analysis and response generation. In step 206 the automated learning system 111 selects an appropriate large language model, and employs it to generate a contextually relevant and coherent response based on the transcribed text data of step 205 and the user's subject of study. In step 207 the automated learning system 111 inserts speech synthesis markup language to the generated text response in step 206 and uses the multilingual speech synthesis or text-to-speech modules to generate audio containing a human-like voice used to emulate a human instructor. In step 208 the automated learning system 111 transmits the synthesized speech audio back to the user through the network 104, ensuring real-time communication during the call. In step 209 the automated learning system 111 continuously assesses the status of the call, either marking it as in-progress if ongoing or completed once the voice call has ended, If the call is still ongoing, the process loops back to listen for new user speech input as per step 210 and continue transcribing, generating responses, synthesizing speech audio, and streaming audio back to the user as per steps 205, 206, 207 and 208. If the call is deemed complete on step 209, the automated learning system 111 stores the session transcripts in a database as per step 211. In step 212 the automated learning system 111 completes the session, sends the session transcripts to the user by email and makes session transcripts accessible through the user interface.

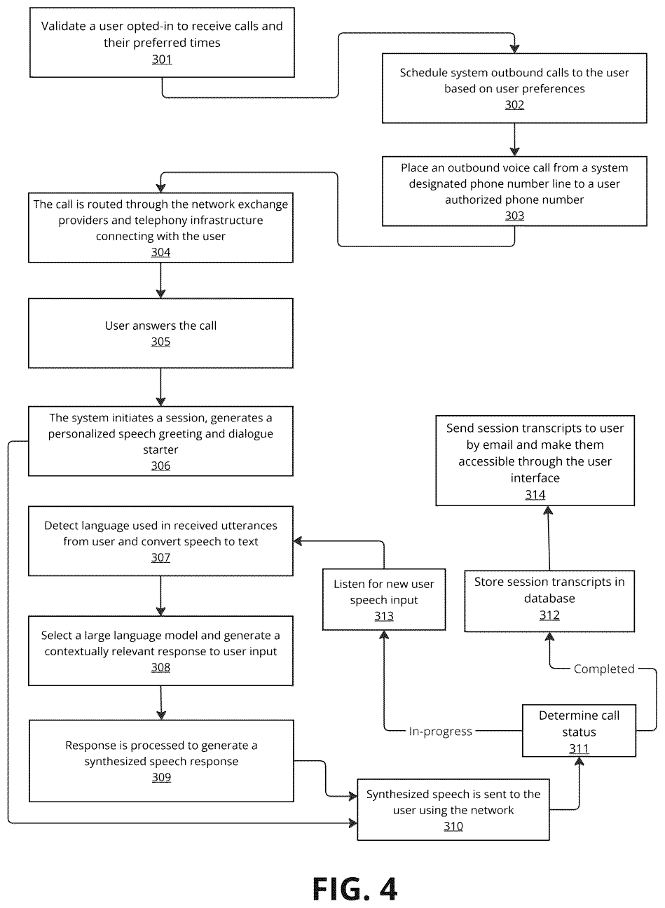

FIG. 4 is a flowchart illustrating the process of initiating an outbound call from the automated learning system to the user's authorized phone number lines, according to one embodiment. In step 301, the automated learning system 111 validates a user opted-in to receive calls and user schedule time preferences. In step 302 the automated learning system 111 schedules calls for teaching or practice sessions with the user, based on the user's preferences. In step 303 the automated learning system 111 detects that it's time for a scheduled call and initiates a call from the automated learning system designated phone number lines 105 to one of the user's authorized phone numbers 106. In step 304 the call is routed through the telecommunications infrastructure and network exchange providers (the network 104), connecting with client device 103A. In step 305 the user answers the call. In step 306, the automated learning system 111 initiates a personalized speech greeting and a conversation starter to guide the learning session and real-time voice interactions with the user 101. In step 307, the automated learning system 111 uses the speech recognition and speech-to-text modules to detect the language used in the user speech input and then converts it into text format for analysis and response generation. In step 308, the system selects an appropriate large language model and generates contextually relevant and coherent responses based on the transcribed text data of step 307 and the user's subject of study. In step 309, the automated learning system 111 inserts speech synthesis markup language to the generated text response created in step 308 and uses the multilingual speech synthesis or text-to-speech modules to generate audio containing a human-like voice used to emulate a human instructor. In step 310 the system transmits the synthesized speech audio back to the user through the network 104. Throughout the duration of the call, the automated learning system 111 continuously assesses the conversation's status, either marking it as in-progress if ongoing or completed once the voice call has ended. If the call is still ongoing, the process loops back to listen for new user speech input as per step 313 and continue transcribing, generating responses, synthesizing speech audio, and streaming audio back to the user as per steps 307, 308, 309, and 310. Upon completion of the call, the system stores the session transcripts in a database as per step 312. In step 314 the automated learning system 111 completes the session, sends the session transcripts to the user by email and makes session transcripts accessible through the user interface.

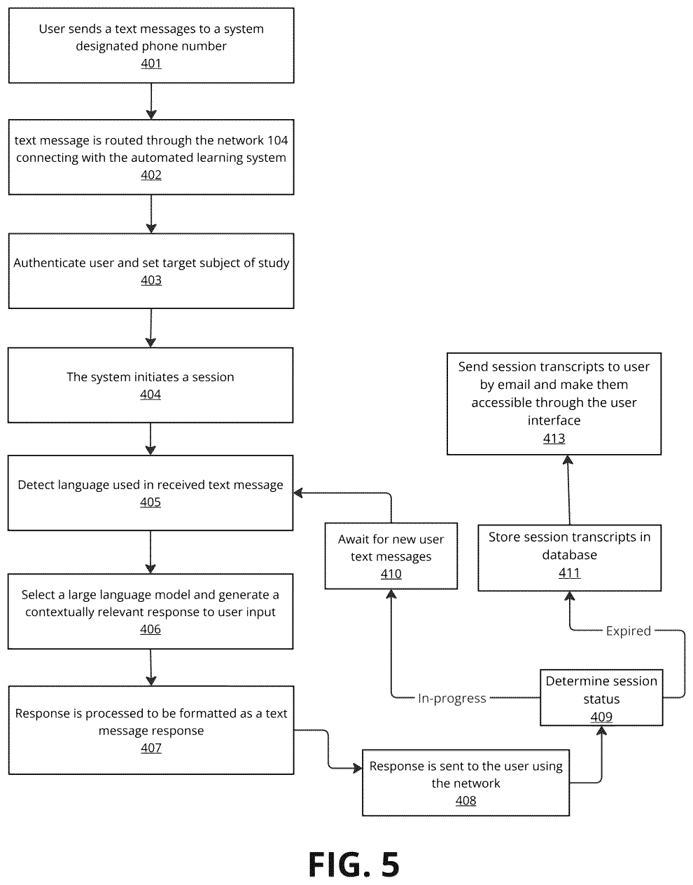

FIG. 5 is a flowchart illustrating the process of handling inbound text messages sent through the short messaging service of the user's carrier network 104A from any of the user's authorized phone numbers 106 and directed at the system designated phone numbers 105, according to one embodiment. In step 401, the automated learning system receives an inbound text message sent by the user from one of the user's authorized phone numbers 106, initiating a new learning session conversation or continuing an ongoing one. In step 402, the text message is routed through the short messaging service of telecommunications infrastructure and network exchange providers (the network 104), connecting with the automated learning system 111. In step 403 the automated learning system 111 authenticates the user by matching the phone number used to send the text message to the automated learning system 111 subscriber database 107 and initializes the user's profile and preferences, such as, subject of study, user preferred language, target language, and any specific topics or goals for the session. In step 404 the automated learning system 111 initiates a session with a timestamp to keep the session open for 24 hours after the initial text message is received. In step 404, the system generates a personalized text greeting based on the user's profile and preferences, such as, subject of study, native language, target language, and any specific topics or goals for the session. In step 405 the system detects the language used in the text messages. In step 406, the automated learning system 111 selects an appropriate large language model 112, and employs it to generate a contextually relevant and coherent response based on the received text message and the subject of study. In step 407, the system formats the large language model response to be processed as a text message. In step 408 the formatted response is sent back to the user as a text message using the network 104. In step 409 automated learning system 111 determines session status, if the session is labeled in-progress the system then continues looping back to await for new user messages as per step 410 and repeats the steps 405, 406, 407, 408 and 409 to respond within the context of an open session and the 24-hour session window. Throughout this process, the system continuously assesses the conversation status, marking it as in-progress if ongoing or completed once the 24-hour session window elapses. Once the conversation ends by reaching the 24-hour window, in step 411 the automated learning system 111 stores the session transcripts in the database 107. In step 413 automated learning system 111 makes the session transcripts accessible through the user interface and sends the session transcripts to the user by email.

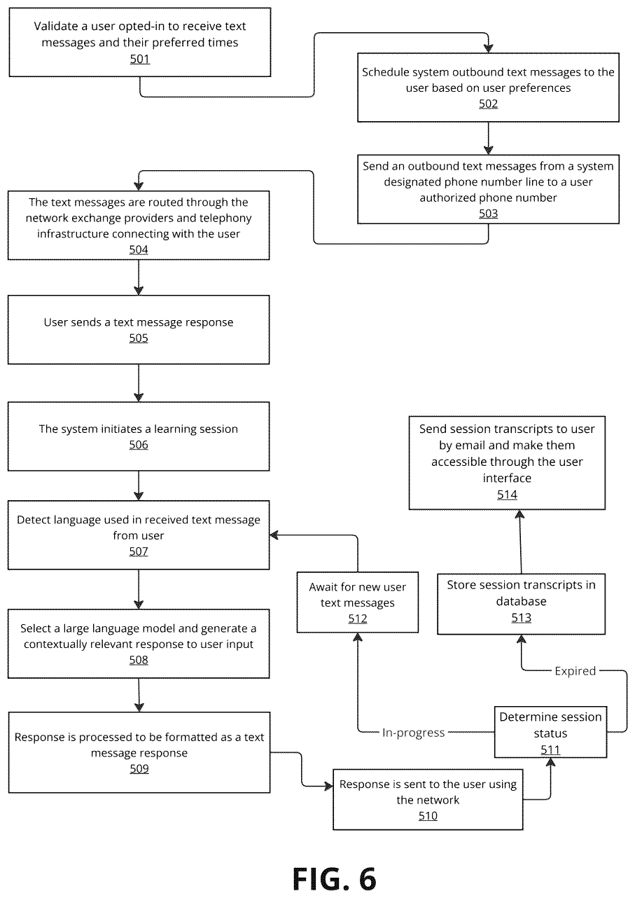

FIG. 6 is a flowchart illustrating the process of handling outbound text messages sent through the short messaging service of the system designated phone number lines 105, directed at the user's authorized phone number lines 106, according to one embodiment. In step 501, the automated learning system 111 validates a user has opted-in to receive text messages and their preferred times. In step 502, the system schedules outbound text messages to the user based on user preferences. In step 503, an outbound text message is sent from a system designated phone number line 105 to one of the user's authorized phone number lines 106. The text messages are routed through network exchange providers and telephony infrastructure (the network 104), connecting with the user as per step 504. In step 505, the user sends a text message response. In step 506 upon receiving the user's text message response, the automated learning system 111 initiates a session with a timestamp to keep the session open for 24 hours after the initial response is received. In step 507, the automated learning system 111 detects the language used in the received text message. In step 508, the automated learning system 111 selects a large language model and generates a contextually relevant response to the user input and subject of study. In step 509, the large language model inference text is processed to be formatted as a text message. In step 510, the response is sent to the user using the network 104. In step 511, the automated learning system 111 determines the session status, if marked in-progress the system loops back to await for new user text messages as per step 512 and repeats steps 507, 508, 509, 510, and 511 to respond within the context of an open session and the 24-hour session window. If the status is expired the automated learning system 111 stores session transcripts in the database as per step 513. In step 514 the automated learning system 111 sends the session transcripts to the user by email and makes them accessible through the user interface.

1. An automated computer-implemented method to facilitate interactive learning by emulating a human instructor's voice and interacting in real-time with a user for teaching a target subject of study via telephony communications, comprising the steps of:
Establishing a telephonic exchange connection with a user, wherein the connection is initiated by receiving a telephonic call contact from a user or initiated by a computer program making a telephonic call contact to a user;
receiving telephonic speech audio input from a user; processing the audio signal using speech recognition and speech-to-text engines to detect language and convert speech audio input to text format for analysis and response generation;
determining context information associated with the speech input transcription, wherein the context information includes a plurality of previously obtained speech input transcriptions and their relationship to the subject of study. When no context information exists the context is set to be the beginning of a learning session related to the subject of study;
Employing programs, such as, artificial intelligence, large language models, speech-to-speech or text generation to generate a contextually relevant and coherent response based on the context, wherein the response is related to a target subject of study context and the speech input received from the user;
Employing programs, such as, multilingual speech synthesis, text-to-speech or speech-to-speech to generate synthetic human-like voice audio using the response generated for the speech input received from the user;
Transmitting back to the user's telephonic device an audio signal that emulates a human instructor's voice and contains a contextually relevant and coherent response in the user's preferred language, or interchangeably between the target language and native language when the field of study is set to learning a foreign language, wherein the language used is determined by the language detected in the most recent user speech input or the user's language proficiency level as per the user preferences.

2. A system to facilitate interactive learning by emulating a human instructor's voice and interacting in real-time with a user for teaching a target subject of study, comprising:
a set of designated phone number lines for users to place and receive voice phone calls that enable 2-way audio interactions in real-time with emulated human instructors;
an automated attendant apparatus configured to make and receive phone calls and route audio signals;
A non-transitory computer-readable storage medium storing one or more programs comprising:
one or more sets of rules for handling a 2-way audio conversation between the user and the emulated human tutor, wherein one or more sets of rules are associated with instructed actions for dynamic call handling;
a rule based decision engine designed to decide which specific tuition modes to engage based on one or more parameters, where the parameters can include, the target subject of study, the language used in each of the speech audio inputs, historical interactions data, user preferences and current session context;
a text generation module that employs large language models to create contextual relevant responses for transcribed user input;
A speech recognition and transcription engine for real-time language detection and transcription of user speech, making speech input available for further processing;
A speech synthesis engine to generate synthetic human-like voice audio for delivering responses in the user's preferred language or interchangeably between a target language and native language for foreign language study;
A user interface enabling initiation of real-time learning sessions from a web browser or dedicated application on the client device.

3. The computer-implemented method of claim 1, wherein speech recognition or speech-to-text engines are utilized for real-time language detection and transcription of user speech received during telephonic learning sessions, making the speech input available for further processing in text form.

4. The computer-implemented method of claim 1, wherein a text generation engine, large language model or speech-to-speech model are used to: generate contextually relevant responses to the audio or text form of the user speech input over the phone; Maintain a coherent conversation related to the subject of study context in the user's preferred language or interchangeably between the target language and native language when the field of study is set to learning a foreign language.

5. The computer-implemented method of claim 1, wherein the contextually relevant text response created by the text generation module is processed by a speech synthesis engine or speech-to-text engine to generate audio containing human-like voices that are immediately played back to the user as a response to the most recent user speech input, maintaining a natural conversation flow between the emulated human instructor's voice and the user.

6. The system of claim 2, wherein the system has the flexibility to switch the synthesized speech language between a user's preferred language and a target language, when the subject of study is set to learning a foreign language. The language used by the emulated tutor is set for each utterance during a learning session voice call based on: the language a user used in the most recent speech input received by the system or a set of rules predefined by user preferences or the system.

7. The system of claim 2, wherein a user interface enables the user to initiate a real-time subject of study learning session voice call with an emulated tutor from a web browser or dedicated application executed in the client device.

8. The system of claim 2, wherein multiple emulated tutor teaching styles are available, wherein teaching styles can include: role-playing exercises, pronunciation exercises, expontaneous conversation engagement, or subject-specific lessons.

9. The system of claim 2, wherein the system initiates outbound voice calls from the automated learning system designated phone number lines to the user authorized phone number lines to initiate real-time subject of study learning sessions with an emulated human instructor or tutor.

10. The system of claim 2, wherein the user initiates an inbound call from user authorized phone number lines directed at the automated learning system designated phone number lines to initiate real-time subject of study learning sessions with an emulated human instructor or tutor.

11. The method of claim 1, wherein a subject of study or a foreign language is taught to a user by emulating a human tutor voice via inbound or outbound telephonic voice calls, engaging in real-time conversational learning sessions related to the user's target subject of study. Inbound refers to a phone call initiated by the user directed to the system of claim 2, and outbound refers to a phone call initiated by the system of claim 2 and directed to a user's authorized phone number lines.

12. The method of claim 11 where telephonic voice calls comprises establishing real-time voice communication with an emulated tutor via:
a. Telephony systems
b. Analog or digital phone lines
c. voice over internet protocol
d. web real-time communication technologies
e. Telephony integrations using programming application interfaces
f. Mobile telephony, such as cellular phones and smartphones.

13. The method of claim 11, wherein teaching a target subject of study to a user by emulating a human tutor voice comprises: Guiding the learning sessions using an emulated human instructor or tutor to deliver personalized lessons based on the user's preferences and previous interactions; Providing feedback on the user's skill acquisition progress; Engaging in bilingual conversations using the native and target language when the subject of study is set to learning a foreign language; Maintaining real-time conversational interactions mimicking everyday situations, workplace training, industry-specific tasks, role-play scenarios, and subject-specific discussions; Conducting proficiency level assessments related to the target subject of study.”

14. In one embodiment of the method of claim 11, teaching a target subject of study to a user involves engaging in conversations via short-message services and generating text with contextually relevant responses to text input received from the user. The conversations are in a tuition context and include: Personalized lessons based on user profile data and previous learning sessions; Learning progress feedback; Bilingual conversations in the native and target language when learning foreign languages; Mimicking everyday situations or industry-specific tasks; Role-play scenarios; Subject-specific conversations; Grammar and spelling corrections; Proficiency level assessments related to the target subject of study.
